(19) United States
(12) Patent Application Publication
(10) Pub. No.: US 2026/0332796 A1
(43) Pub. Date: Oct. 22, 2026

(54) METHODS AND APPARATUS FOR DYNAMIC ENCODING BASED ON MEMORY PERFORMANCE

(71) Applicant: GoPro, Inc., San Mateo, CA (US)

(72) Inventors: Jean-Marc Thiesse, Paris (FR); Maxime Bichon, Paris (FR)

(73) Assignee: GoPro, Inc., San Mateo, CA (US)

(21) Appl. No.: 19/184,992

(22) Filed: Apr. 21, 2025

(51) Int. Cl. H04N 19/423; H04N 19/152; H04N 19/156

(52) U.S. Cl. CPC H04N 19/423; H04N 19/152; H04N 19/156

(57) ABSTRACT

Systems, apparatus, and methods for dynamic encoding based on memory performance. Certain memory technologies decrease in performance as they “age”. Furthermore, memory devices often hide their internal operations from external software. This can create unpredictable issues in applications that have rate limitations (e.g., action photography, etc.). Aspects of the present disclosure infer the performance of a memory device based on buffer capacity to dynamically adjust an encoder's output bit rate. These techniques may be used with both constant bit rate (CBR) and variable bit rate (VBR) encoders.

### RELATED APPLICATIONS

This application is related to U.S. application Ser. No. 18/701,256, filed Apr. 15, 2024, and entitled “METHODS AND APPARATUS FOR REAL-TIME GUIDED ENCODING”, and U.S. application Ser. No. 18/423,533, filed Jan. 26, 2024, and entitled “METHODS AND APPARATUS FOR DYNAMIC CODEC CONFIGURATION”, incorporated herein by reference in their entireties.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records but otherwise reserves all copyright rights whatsoever.

### TECHNICAL FIELD

This disclosure relates to encoding content. Specifically, the present disclosure relates to encoding video content to unreliable media.

### DESCRIPTION OF RELATED TECHNOLOGY

SD cards (Secure Digital cards) are compact, portable storage devices used in cameras, smartphones, gaming consoles, and other electronics. They utilize NAND flash memory to store data without requiring power (non-volatile), making them ideal for mobile and embedded applications. Their performance is influenced by factors such as read/write speeds, file system type, and wear leveling technology. While reliable, SD cards can degrade over time due to repeated write cycles, leading to slower performance and potential data loss.

As a related note, devices that encode video for storage on an SD card often balance several design tradeoffs. Key considerations may include the card's write speed, capacity, and endurance. Video codec and compression settings should also balance quality and file size to optimize storage efficiency while ensuring smooth playback. Additionally, wear leveling and error correction mechanisms are important for longevity (NAND flashes deteriorate with usage and time). Ensuring compatibility with the card's file system (e.g., exFAT for large files) and managing fragmentation can further improve performance and reliability.

### BRIEF DESCRIPTION OF THE DRAWINGS

FIG. 1 is a graphical representation of NOR and NAND memory architectures, useful to explain their differences in operation.

FIG. 2 is a logical block diagram of an encoding system, useful to explain various aspects of the present disclosure.

FIG. 3 is a logical flow diagram of internal write processing which may occur during SD card operation, useful to explain various aspects of the present disclosure.

FIG. 4 illustrates how image quality varies as a function of bitrate for encoding an image of fixed resolution, useful to explain various aspects of the present disclosure.

FIG. 5 depicts a graphical representation of the range of possible bitrates for a target quality, useful for explaining various aspects of the present disclosure.

FIG. 6 is a logical flow diagram of an encoding system, in accordance with various aspects of the present disclosure.

FIG. 7 is a graphical representation of bitrate and queue size relationship, in accordance with various aspects of the present disclosure.

FIG. 8 is a logical block diagram of a dynamic encoding device, in accordance with various aspects of the present disclosure.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### Memory Architectures and Performance

A memory device is any electronic component or system that stores and retrieves digital data from a non-transitory computer-readable medium. Volatile memory devices must periodically refresh data to maintain their integrity; refresh cycles consume power but may provide significant performance benefits—e.g., higher throughput, lower latency, robust storage, etc. Non-volatile memory is stable without power; however, these devices are often slower and prone to data errors.

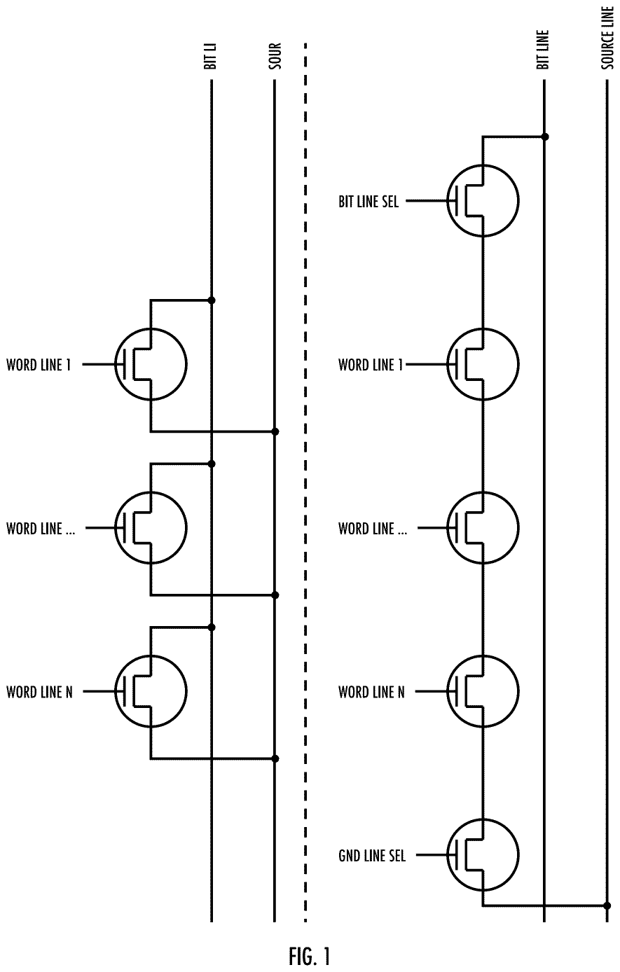

Solid state memory architectures are categorized into NAND and NOR based on their resemblance to NAND/NOR logic gate structures. FIG. 1 graphically depicts NOR and NAND memory architectures, useful to illustrate their differences in operation. Each memory cell is a floating gate transistor. Conceptually, the floating gate transistors operate as an electrical switch that allows/prevents current flow between two terminals (source and drain) based on a floating gate (FG) and a control gate (CG). The FG is interposed between the CG and MOSFET-like channel. The FG can be charged with electrons because it is electrically isolated by an insulating layer. When the FG is charged with electrons, it screens the electrical field from the CG, thus, increasing the threshold voltage of the cell. In other words, the threshold voltage of the cell can be changed between a first threshold voltage (V_{T1}) and a second threshold voltage (V_{T2}) by changing the FG charge. To read a value from the cell, an intermediate voltage (V_{I}) (between V_{T1} and V_{T2}) is applied to the CG. Conduction occurs depending on the state of the FG (charged/uncharged); in other words, the binary state of the cell may be sensed by determining whether there is current flowing through the transistor. If the channel conducts at V_{I}, then the FG is uncharged; if the channel does not conduct at the V_{I}, then the FG is charged. Higher order cell level variants (e.g., multi-level cell (MLC), triple-level cell (TLC), quad-level cell (QLC), etc.) may store and read more than one bit of information per cell using more complex decoding circuitry that can resolve different amounts of current flow.

The NOR memory architecture of FIG. 1 uses a fully addressable memory array that allows direct access to individual bytes or words. Each memory cell (floating gate transistor) has one end connected to source (typically GND) and another end connected to a bit line. When the word line is asserted, the corresponding memory cell pulls the output bit line to the source voltage. In contrast, NAND memory of FIG. 1 connects several memory cells in series. To read a memory cell, all the memory cells, other than the cell of interest, are set to a conduction state (e.g., second threshold voltage (V_{T2})); only the cell of interest is put into an intermediate state—at this point, the FG charge state (charged/uncharged) of the memory cell determines whether the entire group conducts or does not.

As shown and described within FIG. 1, NOR memory architectures allow for individual addressing of a single memory cell whereas NAND memory architectures group memory cells together which enables more dense packing. NAND memory architectures are optimized for sequential read/write operations, making them ideal for high-density storage applications. However, NAND memory performance quickly suffers when access is non-sequential.

NAND memory has a limited number of program/erase (P/E) cycles before cells degrade and become unreliable. As memory cells wear out, they are more prone to write errors. Aggressive manufacturing targets and high-density architectures may also introduce yield issues that affect memory cell reliability (e.g., silicon defects may render memory cells unusable). The grouped structure of NAND memory further exacerbates these issues, since a single memory cell affects its entire group's performance.

Memory manufacturers have developed a variety of different techniques to improve reliability and lifespan of memory devices. For example, onboard memory management logic may attempt to compensate for and/or obfuscate underlying memory issues. For example, the memory management may use wear leveling technologies to distribute writes evenly and to avoid “hot spots” of unusable media. Error correction codes (ECCs) are used to detect and fix errors. When error rates exceed correction capability, the memory management logic may re-map data to spare memory arrays.

For a variety of security, performance, and reliability reasons, memory management logic is typically hidden and/or shielded from external access. Nonetheless, the underlying health of the memory medium may be surmised from a reduction in performance. In other words, as the number of program/erase (P/E) cycles increases, the number of write and/or read errors will also increase. The resulting additional error correction, wear-leveling, and/or re-mapping to spare memory arrays will introduce additional delay that increase access latency and/or reduce system throughput. Performance degradation may be especially noticeable in NAND architectures which are optimized for sequential accesses.

NAND memory technologies are commonly found in consumer electronics devices. For example, Secure Digital (SD) cards are often used as removable media in cameras, phones, laptops, etc. Their compact size, low cost, high performance, and reliability is ideal for many applications in consumer electronics.

SD cards come in a variety of different card formats which provide different storage capacities and/or file system support. For example, so-called SD High Capacity (SDHC) supports FAT32 file formats; FAT32 handles individual files up to 4 gigabytes (GB) and may range in total capacity between 4 GB and 32 GB. SDHC SD cards are legacy cards that are commonly used in cameras, smartphones, and other general storage applications. So-called SD extended Capacity (SDXC) supports exFAT file formats; exFAT supports larger file sizes thus SDXC cards range from 64 GB to 2 terabytes (TB). SDXC cards require special file system support and are usually found in high-definition video recording, gaming consoles, and/or professional photography applications. So-called SD Ultra Capacity (SDUC) use exFAT and provide even more storage capacity (2 TB to 128 TB)—these devices may only be used in SDUC-compatible devices. More generally, devices that support newer formats may read older formats, but older devices may not support newer formats due to file system and capacity limitations.

Memory manufacturers have become increasingly aggressive with their NAND memory architecture optimizations. For example, single-level cell (SLC) NAND typically has ~50,000 to ~100,000 P/E cycles but is now exceedingly rare in consumer electronics SD Cards. Multi-level cell (MLC) NAND typically provides ~3,000 to ~10,000 P/E cycles, this technology was previously used in SDHC and SDXC cards but is quickly being supplanted by triple-level cell (TLC) NAND. TLC NAND provides about ~100 to ~1000 P/E cycles and is quite popular in consumer grade SDHC, SDXC, and SDUC cards. Recently, quad-level cell (QLC) is rapidly gaining traction in SDXC and SDUC cards, especially budget models. Unfortunately, unwary consumers often purchase memory cards based on capacity, without necessarily realizing that such high-density correlates to much lower program/erase (P/E) lifetimes.

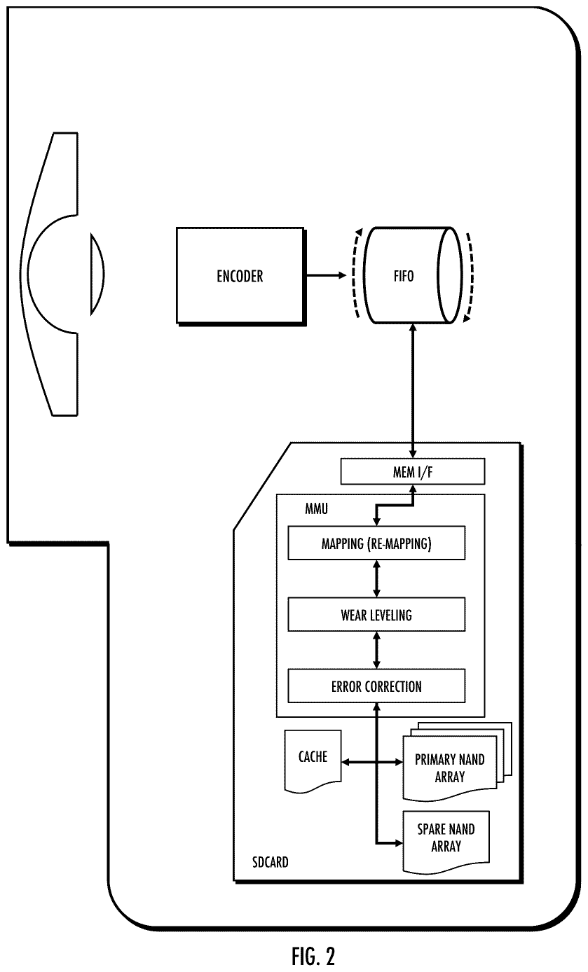

Consider the encoding system of FIG. 2. Here, sequentially captured images are encoded into video and written to a memory buffer. The video encoder compresses sequential image data into a video format. Examples of video compression algorithms may include e.g. H.264, H.265 (HEVC), AV1, or VP9. Conventional algorithms analyze the image data and remove redundant spatial/temporal information to preserve motion and detail for smooth playback, according to a fixed bitrate (so-called iso-bitrate encoding or constant bitrate encoding (CBR)).

The memory buffer is a FIFO (First-In, First-Out) buffer; data is sequentially written at a write pointer and read from a read pointer. The FIFO buffer stores and manages data according to the order the data was received. Here, the FIFO compensates for the bursty encoding and memory write procedures without loss or reordering. The FIFO typically only stores a rolling window of data (e.g., about 1 second worth of footage). From a data flow standpoint, the FIFO is filled and drained at the same throughput, however each side may have different rates, latencies, and/or burst sizes. Filling the FIFO faster than it can be drained will result in an overflow (if allowed to write unchecked). Similarly, draining the FIFO faster than it can be filled will result in an underflow. Typically, underflows are not an issue for a memory since they attempt to match their drain throughput to the fill throughput. However, an active endpoint that consumes data at a specified throughput can experience underflow issues if there is a mismatch.

The SD card is a removable memory device that is composed of many different components that work together to manage data accesses (reads and writes) to provide reliable, robust, performance and extend usable lifetime. The mapping (re-mapping) logic, wear leveling, and error correction logic, are of particular interest, since they directly affect memory card latency, throughput, and other performance metrics.

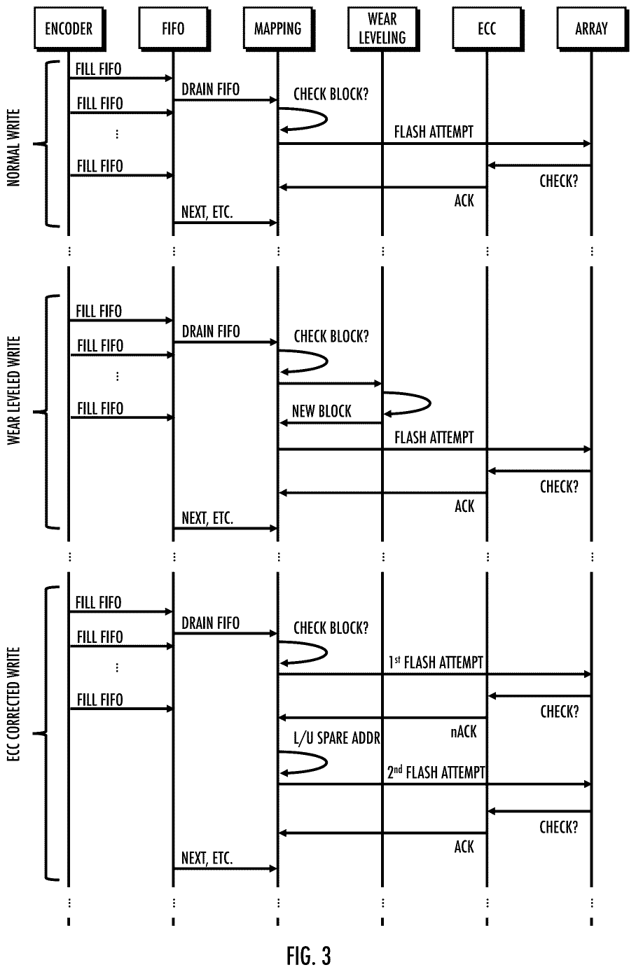

FIG. 3 is a logical flow diagram of internal write processing which may occur during SD card operation. The FIFO is filled with video data from the encoder, and drained as it is written to the SD card. As previously alluded to, the drain throughput attempts to match the fill throughput; here, the FIFO is filled in bursts and drained a bit at a time.

First, consider a “normal” write process. The mapping/re-mapping logic manages how data is written from the system memory interface to NAND flash memory. Specifically, the encoder writes data using logical block addresses (LBA) of a memory bus, which must be translated into the physical addressing that corresponds to the pages and blocks of the underlying NAND memory architecture. For example, a NAND silicon chip may have a number of dies, each die may be segmented into planes, each plane may be segmented into blocks, and each block may be further segmented into a number of pages. A block might have 64, 128, 512, etc. pages; each page might have 2 KB, 4 KB, 8 KB, etc. of memory. The locations in the pages of the block can only be programmed once for each P/E cycle; erasure must occur at the block level before the pages may be re-programmed. So long as the blocks still have pages available for writes, the mapping logic attempts to flash the data to the physical page location of the array. The written data is read back and checked by the error correction code (ECC) logic. If the ECC acknowledges (ACK) that the written data is uncorrupted, the next location may be read.

Referring now to the write process with wear leveling-here, the mapping/re-mapping logic translates the LBA of the write to blocks and pages of the NAND array. However, in this case, the mapping/re-mapping logic determines that the block is out of pages; in response, it requests new blocks from the wear leveling logic. Wear leveling logic assigns blocks to distribute accesses and avoid “hot spots” across the blocks. There many variants of wear leveling; for example, so-called “dynamic wear leveling” re-distributes blocks that contain frequently written data to areas with lower P/E cycles, “static wear leveling” moves less frequently written data to areas with higher P/E. The wear leveling logic provides a new block allocation to the mapping/re-mapping logic, which can proceed as discussed above.

Lastly, consider the ECC corrected write process. In this case, the write proceeds as discussed above, however, the written data fails the ECC check; in this case, the ECC logic provides a non-acknowledge (nACK) indicating that the block failed the write. The mapping/re-mapping logic maps a new block from its existing allocation, a new allocation provided from wear leveling logic, or from a spare NAND array, and attempts a re-write. The re-write process may entail multiple iterations, if necessary.

Many SD cards may include additional components to further improve performance. For example, an SD card may incorporate small portions of fast memory (e.g., volatile SRAM, etc.) that can be used to temporarily store incoming data before committing the data to the NAND flash array. This cache may smooth out write performance and also allow smaller writes to be combined into larger sequential writes (reducing fragmentation and increasing lifespan). Caches may also be used to store frequently accessed data for faster reads and/or prefetch data to provide faster sequential reads. Some SD cards may use a portion of NAND memory in SLC mode to allow for reliable writes; the memory may later be transferred to TLC or QLC NAND at a more leisurely rate. Cache memory (when present) is likely to be more expensive and much smaller than the NAND array, since it augments (but does not replace) the NAND array.

As P/E cycles accumulate over time, bad blocks will increase resulting in more frequent wear leveling and/or re-writes. In other words, as a memory device ages, its performance steadily decreases. If the SD card cannot match its drain throughput to the fill throughput of the encoder, then the mismatch will cause an overflow. In other words, the encoder outpaces the FIFO and corrupts the ongoing capture. This may be particularly frustrating where the difference in drain throughput and fill throughput is not large enough to immediately detect, but sufficient to cause corruption after several minutes of recording. Internal caching can also mask problematic behavior, further confusing attempts to pinpoint root cases.

While the foregoing discussion is presented with reference to a specific order of operations, artisans of ordinary skill in the related arts will readily appreciate that the functionality, ordering, and/or protocol, widely varies across implementations; for example, some implementations may perform mapping (re-mapping) after wear-leveling, etc. The illustrations and discussions provided throughout are merely for explanatory purposes.

### Dynamic Encoder Configuration

Dynamic encoder configuration may be used to adjust a variety of different operational parameters to e.g., improve memory usage, reduce encoding complexity, prolong battery life, reduce temperature, etc. Dynamic encoding techniques are discussed in greater detail within U.S. application Ser. No. 18/701,256, filed Apr. 15, 2024, and entitled “METHODS AND APPARATUS FOR REAL-TIME GUIDED ENCODING”, and U.S. application Ser. No. 18/423,533, filed Jan. 26, 2024, and entitled “METHODS AND APPARATUS FOR DYNAMIC CODEC CONFIGURATION”, each of the foregoing previously incorporated by reference in their entireties.

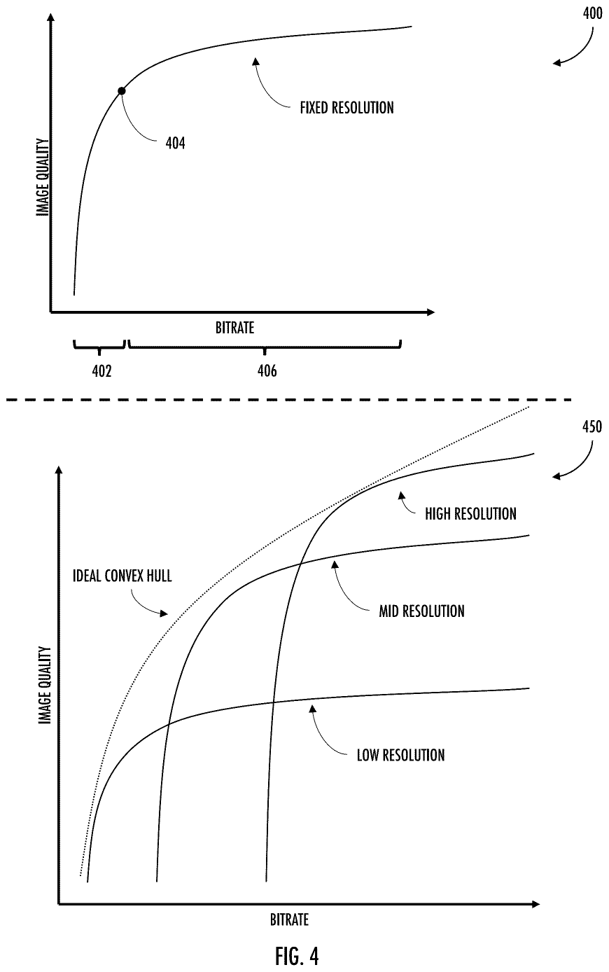

Dynamic encoding techniques (also referred to as variable bitrate (VBR) encoding) seek to optimize the encoding process for an optimization target. Optimization techniques generally seek to balance multiple constraints; for example, a dynamic encoding technique might attempt to trade-off between bitrate, quality, and computational complexity, etc. Most trade-offs have some form of diminishing return. For example, a first bitrate-quality curve 400 of FIG. 4 illustrates how image quality varies as a function of bitrate for encoding an image of fixed resolution. The first bitrate-quality curve 400 is characterized by a region of steep ascent 402, a kink 404, and a plateau region 406. As shown, larger increases in bitrate are needed to achieve smaller increases in image quality in the plateau region 406.

FIG. 4 also compares multiple bitrate-quality curves 450 for different resolutions (scaled for comparison). At lower bitrates, low resolution encodings have an edge since fewer pixels are encoded. As the bitrate increases, however, the low-resolution curve quickly reaches a natural limit of fidelity. Higher resolutions are harder to encode at low bitrates, but the number of bits eventually becomes enough to encode higher quantities of pixels resulting in a higher image quality (when compared to upscaled lower resolutions).

The observed relationship between bitrates, image quality, and resolution has been experimentally explored by others. For example, Per-title Encode Optimization published Dec. 14, 2015 by Aaron et al. at https://netflixtechblog.com/per-title-encode-optimization-7e99442b62a2, last retrieved Dec. 29, 2023 (hereinafter “Aaron”), incorporated herein by reference in its entirety, observes that “each resolution has a bitrate region in which it outperforms other resolutions”. Combining these points describes a “convex hull” that identifies the point of diminishing returns (kink) for all bitrate-resolution combinations. Aaron uses the convex hull to search for practical bitrate-resolution pairs that provides acceptable performance. Aaron is representative of most conventional dynamic encoding works. Table 1 provides a brief summary of other notable works in this area.

TABLE 1
Notable Dynamic Encoding Implementations

| Notable | | | |
|---|---|---|---|
| Implem.: | Application: | Optimization Target: | Technique: |
| Netflix | VOD | Bitrate-Resolution Pairs | Exhaustive |
| (Aaron et al.) | | | Search |
| Athena Lab | Live, VOD | Bitrate-Resolution Pairs | ML Prediction |
| INSA Rennes | Live, VOD | Bitrate-Resolution Pairs | ML Prediction |
| Bhat et al. | Live | Resolution | ML Prediction |

Most research into encoding techniques have been focused on dynamically encoding video for bandwidth and/or playback considerations. For example, VOD services are often limited to a few commonly supported resolutions (1080p, 4K, etc.) and must fit their services within available network capacity (bitrates). Live streaming is similarly constrained. Practical solutions for these applications generally focus on fixed “ladders” of bitrate-resolution pairs. Table 2 provides an example of a bitrate-resolution ladder described by Aaron.

TABLE 2
Notable Dynamic Encoding Implementations

| Bitrate (kbps) | Resolution |
|---|---|
| 235 | 320 × 240 |
| 375 | 384 × 288 |
| 560 | 512 × 384 |
| 750 | 512 × 384 |
| 1050 | 640 × 480 |
| 1750 | 720 × 480 |
| 2350 | 1280 × 720 |
| 3000 | 1270 × 720 |
| 4300 | 1920 × 1080 |
| 5800 | 1920 × 1080 |

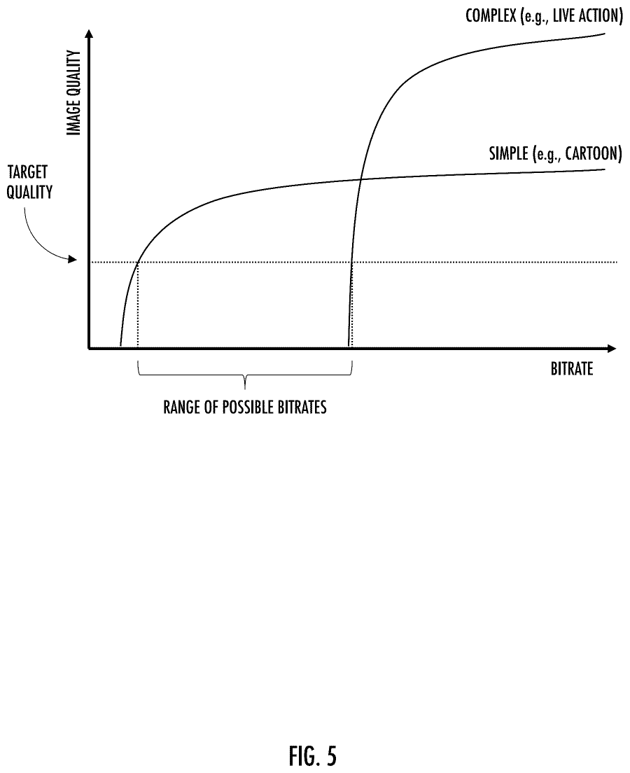

Importantly, these ladders are applied to all videos, regardless of their content. Although they are chosen to produce good encodings for most generic content, they are not individually selected for specific content (titles). An interesting example is live-action content versus animation content. Due to the simple nature of cartoons, sufficient quality can be achieved at lower bitrates, even for high resolutions. On the other hand, complex textures and movement in live action demands more bits in their encodings. This effect is illustrated in FIG. 5. with the rate-quality curves of videos of different complexity but encoded with the same encoder configuration. Conceptually, this is because the actual resolution of the physical display (“display resolution”) is different than the resolution required to render perceptually acceptable content. VOD and live streaming applications take the practical approach of addressing known constraints (e.g., available network bandwidth and display resolution), which is easier task than trying to ascertain what might be “perceptually acceptable” for each title.

### Exemplary Dynamic Encoding Based on Memory Performance

GoPro, Inc. is a camera manufacturer that specializes in action camera photography. Action cameras have unique application requirements that are different than other cameras and/or media services. For example, certain types of action photography may have e.g., irregular/unpredictable subject (and/or camera) motion, long shooting sessions in unforgiving and unpredictable environments, etc. As a practical matter, this may mean that footage cannot be re-shot if the capture opportunity is missed and/or cannot be interrupted once started. Additionally, action photography is often used to capture events with special significance and/or interest for the user (as opposed to share-and-forget style social media posts, etc.). Since they are often used in situations that differ from traditional photography, action cameras are especially vulnerable to buffer overflow errors caused by SD cards.

Furthermore, many users are unfamiliar with the underlying operation of memory devices. They may mistakenly believe that a larger capacity SD card provides “better” performance. However, as noted above, SD card manufacturers are aggressively pushing for larger memory sizes, at the expense of P/E cycles. In fact, many SD card manufacturers may incorrectly assume that the SD card will be utilized in a high-level OS which relies on, and thus accommodates, best-effort scheduling (variable throughput, etc.). In other words, such devices may be optimized for archival storage (infrequent writes) rather than real-time applications (sustained throughput, low latency, etc.). This is further complicated by caching mechanisms which may hide the underlying NAND storage performance behind cache memories that are smaller, faster, volatile, etc.

Various embodiments of the present disclosure dynamically adjust encoder operation to match the performance of its memory device. Since the internal operations of the memory device may not be directly observed (e.g., internal SD card operation may be hidden and/or shielded from external access), a dynamic control logic may throttle the encoder output bitrate based on the dynamically changing FIFO size. For example, the memory performance may be inferred from the rate at which a FIFO is filled minus the rate it is drained. More generally, dynamic control logic may monitor the encoder and FIFO and use feedback (retroaction) to select encoder configurations that prevent buffer overflows.

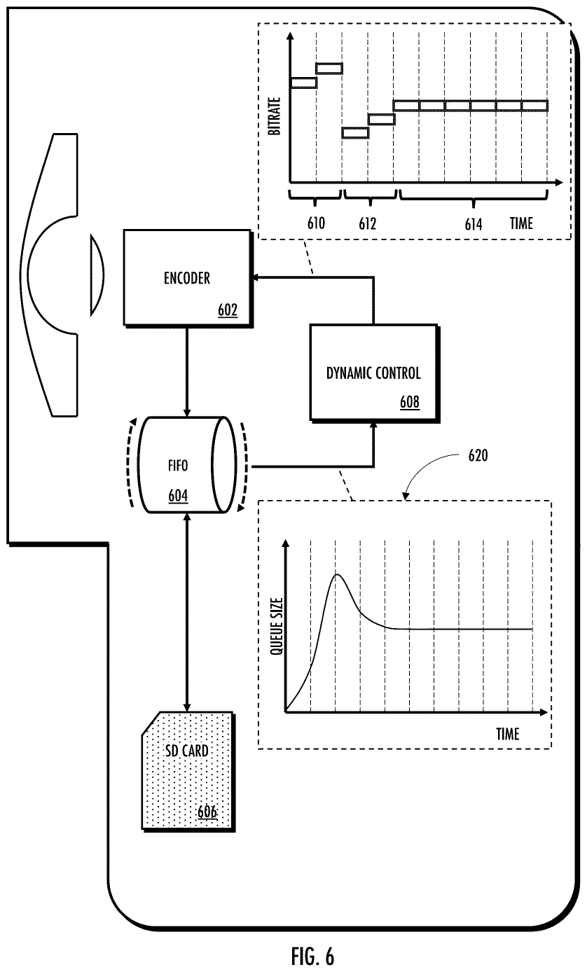

Consider the system diagram of FIG. 6. Here, an encoder 602 fills a FIFO 604, and the FIFO drains to the SD card 606. In the illustrated embodiment, the SD card's internal operations are hidden from the camera and are inferred from external observations. Specifically, dynamic control logic 608 periodically reads the write pointer and the read pointer of the FIFO to determine a FIFO queue size. A mismatch in fill throughput and drain throughput is inferred from changes in FIFO queue size; in other words, if the FIFO queue size grows, then the FIFO is not draining fast enough (which could be attributed to too many write errors at the SD card). While the illustrated example is based on fill throughput and drain throughput, other variants may use fill rate, drain rate, and/or any combination or derivative of rate, throughput, etc.

As used herein, the term “rate” refers to an instantaneous or average speed/frequency e.g., of transfer, access, or other operation. As used herein, the term “throughput” refers to an amount (e.g., output of a process, etc.) over a time interval. While rate and throughput are closely related, they are distinct—for example, some processes are rate-constrained (throughput may vary) or throughput-constrained (rate may vary).

At time 610, the initial difference between the write pointer and the read pointer is 0 (since the FIFO queue is empty); thus, the encoder's initial bitrate may be quite high. In some cases, the initial bitrate may be set based on a user input (e.g., a desired quality, resolution, framerate, etc.). Some amount of encoder pipeline latency is expected, and the FIFO queue begins to fill up (graph 620 depicts queue size as a function of time). In dynamic variants, the encoder's bitrate may additionally throttle up/down based on other considerations such as captured content, performance ramping, etc.

Dynamic control logic 608 monitors the FIFO queue size (graph 620) and detects a memory bottleneck. In one specific implementation, the FIFO queue size is periodically measured (e.g., at 1 second intervals, etc.). Monitoring may be increased or decreased in frequency and/or sensitivity e.g., to suit a variety of different considerations. For example, shorter intervals may allow for more responsive adjustments, less frequent intervals may consume less power. Threshold sensitivity may also be adjusted to identify issues more or less quickly, etc. Different combinations of frequency and/or sensitivity may be used to avoid undershoot/overshoot conditions (e.g., where corrective actions are too conservative or aggressive).

In some variants, the memory bottleneck may be detected based on an absolute magnitude of the FIFO queue size (the total number of elements in queue exceeds an acceptable threshold). In some variants, the memory bottleneck may be detected based on a rate of change of the FIFO queue size (the rate at which the queue grows exceeds an acceptable threshold). In still other variants, the memory bottleneck may be detected based on a FIFO throughput (the number of successful transfers per unit time falls below an acceptable threshold). Various other detection criteria may be substituted with equivalent success.

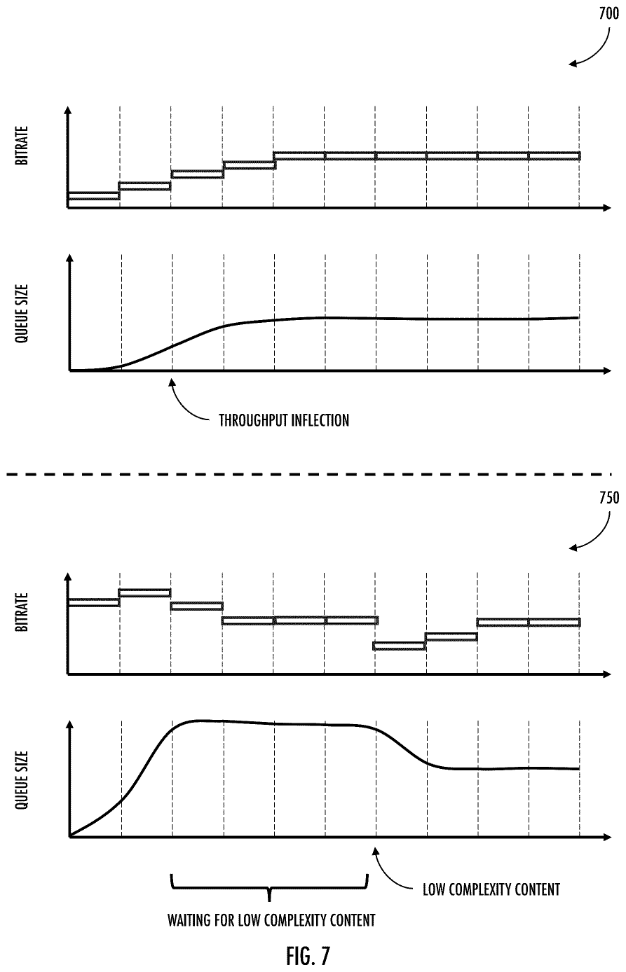

In response to detecting a memory bottleneck, the dynamic control logic 608 reduces the bitrate (time 612). In FIG. 6, the dynamic control logic 608 decreases the bitrate to allow the FIFO to drain, and then incrementally ramps up bitrate to achieve steady state (time 614). The dynamic control logic of FIG. 6 is purely illustrative; other dynamic behavior may be substituted with equal success. For example, sudden abrupt changes in bitrate may be undesirable from an aesthetic standpoint—the dynamic behaviors illustrated in FIG. 7 may provide reasonable alternatives. In a first such variant, the dynamic control logic may start conservatively and ramp up until an inflection point is found in the drain rate—in other words, it is possible to increase encoder output bitrate consistent with the encoder's maximum bitrate capacity, so long as the memory can keep up (see bitrate and queue size relationship 700). In another such variant, the dynamic control logic may tolerate some amount of running disparity; this may be useful to adjust bitrates when low complexity content is identified (see bitrate and queue size relationship 750 of FIG. 7).

While the foregoing discussion is presented within the context of a “steady state” bitrate, artisans of ordinary skill in the related arts will readily appreciate that the concepts may be broadly extended to other encoding strategies. For example, fixed bitrate implementations may achieve substantially similar effects by adjusting the “target bitrate” to the appropriate steady state rate. Similarly, dynamic bitrate implementations that prioritize other shooting parameters (e.g., image quality, resolution, frame rate, power consumption, etc.) may achieve substantially similar effects by adjusting the “maximum bitrate” to the appropriate steady state rate.

As used herein, “steady state bitrate” and its linguistic derivatives refers to a bitrate that is maintained over time. Encoding parameterization is imprecise, thus steady state bitrates may have acceptable tolerances in variance, peaks, valleys, etc. As used herein, a “target bitrate” refers to an average bitrate that an encoder will attempt to achieve across an entire bitstream (typically, as specified by an encoding standard). As used herein, a “maximum bitrate” refers to a bitrate that an encoder cannot exceed at any moment.

Various embodiments of the present disclosure notify the user of ongoing dynamic encoding and/or memory performance. Providing feedback to the user during an ongoing capture may allow the user to adjust and/or accommodate their memory card mid-capture. For example, the user may stop the current capture, and switch to a different SD card, before the action starts. As another example, the user may adjust their shooting complexity (e.g., zooming-in on just the details that matter to them, zooming-out to reduce motion complexity, etc.). In some cases, the user may even choose to “override” the warning and risk a buffer overflow.

In some variants, the card history may additionally be used to categorize the card's suitability for use in action photography scenarios. The severity and frequency of bitrate modification may be used to infer the underlying card performance (e.g., low, medium, high). Different types of action photography may have different criteria—for example, action cameras may be used in short, high-intensity captures as well as long, low-intensity captures, etc. Low light and/or low contrast shooting may also tolerate severe bitrate reductions with negligible difference.

Various aspects of the present disclosure create new opportunities to troubleshoot, accommodate, and prepare for memory performance issues. As a brief aside, conventional solutions for SD card advisories are designed for generic SD card applications. Consider, for example, the “BlackMagic Disk Speed Test” application (see e.g., https://apps.apple.com/us/app/blackmagic-disk-speed-test/id425264550?mt=12 last accessed Mar. 24, 2025). Such applications write and read back test data to memory using large blocks of test data. The results may be graphically displayed in a variety of formats (e.g., speed dials, tables, etc.). Typically, such tests rely on canned test data of fixed size to keep the test evaluation to a tractable complexity and length. The information that may be gathered using these “pre-canned” tests are not representative of live data of unknown complexity and/or length. Furthermore, many of these tests may not distinguish, or allow a user to discern, the distinction between the NAND memory array performance and other memory optimizations (e.g., SRAM caching) that the memory may have enabled. For example, an onboard SRAM cache may provide fast burst rates that mask underlying NAND memory issues over time.

Various embodiments of the present disclosure may provide metrics and/or diagnostics during ongoing capture. User interface options may be used to provide different notification modalities, according to different usage scenarios. Text notifications may provide e.g., estimated queue size, estimated time to queue overflow, instantaneous queue utilization, etc. Text notifications may be provided to the user via the camera's onboard user interface or sent to a connected device (e.g., smart phone, or similar). Graphical user interfaces may display information as a function of time. For example, a graphical plot may provide queue size and/or configured bitrate as a function of time. Color codes, dials, and/or tables may also be used with dynamic information (e.g., updates in real-time, etc.). In some cases, remote messaging, audible alerts, and/or haptic alerts may be used when a user is unable to look at the screen, or after a screen has been powered-off (e.g., to save power while recording, etc.).

As but one such example, a user may intend to start a long-running capture but immediately notice that a running estimate of time to memory overflow will expire before their capture finishes. In some variants, this may be incorporated within “remaining duration” notifications and/or may be provided separately as a “time to buffer overflow”. While these are related concepts, “time to buffer overflow” may be based on a buffer space, whereas “remaining duration” is more typically calculated on available bulk memory—e.g., a buffer overflow issue can ruin a capture even when there is still bulk memory available. The notifications may allow a user to prepare and/or plan for their reduced shooting time accordingly (e.g., restart the capture closer to a point of interest and/or replace the memory card). In some cases, they may be unable to modify shooting time and instead reduce the image complexity and/or memory burden (e.g., zooming-out to capture more detail, zooming-in to reduce disparate motion vectors, enabling/disabling in-camera image stabilization to improve compression, etc.).

While this information may be useful in an ongoing capture, the information may also be used to troubleshoot memory performance that would be otherwise difficult to capture. For example, a time-varying graph of memory performance may be used to identify how long NAND memory performance may be masked with onboard SRAM caching for a specific SD card. As another example, a SD card may “age out” of long-running, high-image quality applications, but may still be useful for lower-image quality, slow-motion, etc. Various other applications may be enabled and/or substituted by artisans of ordinary skill in the related arts, given the contents of the present disclosure.

### System Architecture

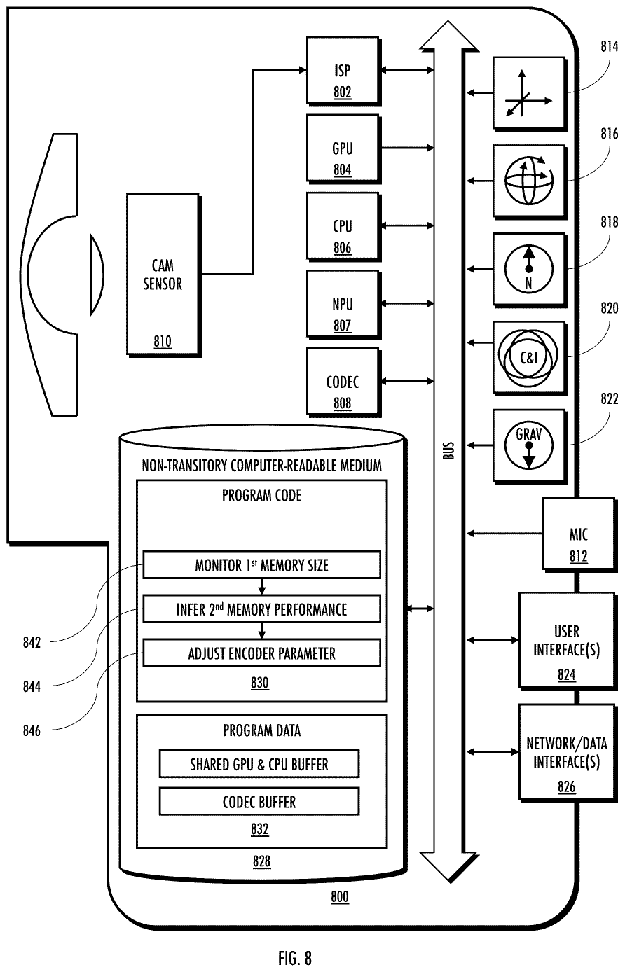

FIG. 8 is a logical block diagram of a dynamic encoding device 800. The dynamic encoding device 800 includes: a sensor subsystem, a user interface subsystem, a communication subsystem, a control and data subsystem, and a bus to enable data transfer. The following discussion provides a specific discussion of the internal operations, design considerations, and/or alternatives, for each subsystem of the dynamic encoding device 800.

As used herein, the term “real-time” refers to tasks that must be performed within definitive constraints; for example, a video camera must capture each frame of video at a specific rate of capture (e.g., 30 frames per second (fps)). As used herein, the term “near real-time” refers to tasks that must be performed within definitive time constraints once started; for example, a smart phone may use near real-time rendering for each frame of video at its specific rate of display, however some queueing time may be allotted prior to display.

Unlike real-time tasks, so-called “best-effort” refers to tasks that can be handled with variable bit rates and/or latency. Best-effort tasks are generally not time sensitive and can be run as low-priority background tasks (for even very high complexity tasks), or queued for cloud-based processing, etc.

While the following discussion is presented in the context of a capture device that performs variable bitrate encoding (VBR), artisans of ordinary skill in the related arts will readily appreciate that the techniques may be broadly extended to constant bitrate (CBR) devices. Furthermore, the concepts are not limited to capture-based systems, other topologies and/or systems may be substituted with equal success. For example, a capture device may provide a live stream to a dynamic encoding device. As another such example, a dynamic encoding device may obtain archival video for transcoding to another memory format.

The following discussion provides functional descriptions for various logical entities of the dynamic encoding device 800. Artisans of ordinary skill in the related art will readily appreciate that other logical entities that do the same work in substantially the same way to accomplish the same result are equivalent and may be freely interchanged. A specific discussion of the structural implementations, internal operations, design considerations, and/or alternatives, for each of the logical entities of the dynamic encoding device 800 is separately provided below.

The techniques described throughout may be broadly applicable to consumer electronics devices such as cameras including action cameras, digital cameras, digital video cameras; cellular phones; laptops; smart watches; and/or IoT devices. For example, a smart phone or laptop may be able to capture and process video. Various other applications may be substitute with equal success by artisans of ordinary skill, given the contents of the present disclosure.

Functionally, the sensor subsystem senses the physical environment and captures and/or records the sensed environment as data. In some embodiments, the sensor data may be stored as a function of capture time (so-called “tracks”). Tracks may be synchronous (aligned) or asynchronous (non-aligned) to one another. In some embodiments, the sensor data may be compressed, encoded, and/or encrypted as a data structure (e.g., MPEG, WAV, etc.)

The illustrated sensor subsystem includes: a camera sensor 810, a microphone 812, an accelerometer (ACCL 814), a gyroscope (GYRO 816), and a magnetometer (MAGN 818).

Other sensor subsystem implementations may multiply, combine, further sub-divide, augment, and/or subsume the foregoing functionalities within these or other subsystems. For example, two or more cameras may be used to capture panoramic (e.g., wide or 360°) or stereoscopic content. Similarly, two or more microphones may be used to record stereo sound.

In some embodiments, the sensor subsystem is an integral part of the dynamic encoding device 800. In other embodiments, the sensor subsystem may be augmented by external devices and/or removably attached components (e.g., hot-shoe/cold-shoe attachments, etc.) The following sections provide detailed descriptions of the individual components of the sensor subsystem.

A camera lens bends (distorts) light to focus on the camera sensor 810. In one specific implementation, the optical nature of the camera lens is mathematically described with a lens polynomial. More generally however, any characterization of the camera lens' optical properties may be substituted with equal success; such characterizations may include without limitation: polynomial, trigonometric, logarithmic, look-up-table, and/or piecewise or hybridized functions thereof. In one variant, the camera lens provides a wide field-of-view greater than 90°; examples of such lenses may include e.g., panoramic lenses 120° and/or hyper-hemispherical lenses 180°.

The camera sensor 810 senses light (luminance) via photoelectric sensors (e.g., CMOS sensors). A color filter array (CFA) value provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image.

More generally however, the various techniques described herein may be broadly applied to any camera assembly; including e.g. narrow field-of-view (30° to) 90° and/or stitched variants (e.g., 360° panoramas). While the foregoing techniques are described in the context of perceptible light, the techniques may be applied to other EM radiation capture and focus apparatus including without limitation: infrared, ultraviolet, and/or X-ray, etc.

As a brief aside, “exposure” is based on three parameters: aperture, ISO (sensor gain) and shutter speed (exposure time). Exposure determines how light or dark an image will appear when it's been captured by the camera(s). During normal operation, a digital camera may automatically adjust one or more settings including aperture, ISO, and shutter speed to control the amount of light that is received. Most action cameras are fixed aperture cameras due to form factor limitations and their most common use cases (varied lighting conditions)—fixed aperture cameras only adjust ISO and shutter speed. Traditional digital photography allows a user to set fixed values and/or ranges to achieve desirable aesthetic effects (e.g., shot placement, blur, depth of field, noise, etc.).

The term “shutter speed” refers to the amount of time that light is captured. Historically, a mechanical “shutter” was used to expose film to light; the term shutter is still used, even in digital cameras that lack of such mechanisms. For example, some digital cameras use an electronic rolling shutter (ERS) that exposes rows of pixels to light at slightly different times during the image capture. Specifically, CMOS image sensors use two pointers to clear and write to each pixel value. An erase pointer discharges the photosensitive cell (or rows/columns/arrays of cells) of the sensor to erase it; a readout pointer then follows the erase pointer to read the contents of the photosensitive cell/pixel. The capture time is the time delay in between the erase and readout pointers. Each photosensitive cell/pixel accumulates the light for the same exposure time, but they are not erased/read at the same time since the pointers scan through the rows. A faster shutter speed has a shorter capture time, a slower shutter speed has a longer capture time.

A related term, “shutter angle” describes the shutter speed relative to the frame rate of a video. A shutter angle of 360° means all the motion from one video frame to the next is captured, e.g., video with 24 frames per second (FPS) using a 360° shutter angle will expose the photosensitive sensor for 1/24^{th} of a second. Similarly, 120 FPS using a 360° shutter angle exposes the photosensitive sensor 1/120th of a second. In low light, the camera will typically expose longer, increasing the shutter angle, resulting in more motion blur. Larger shutter angles result in softer and more fluid motion, since the end of blur in one frame extends closer to the start of blur in the next frame. Smaller shutter angles appear stuttered and disjointed since the blur gap increases between the discrete frames of the video. In some cases, smaller shutter angles may be desirable for capturing crisp details in each frame. For example, the most common setting for cinema has been a shutter angle near 180°, which equates to a shutter speed near 1/48^{th} of a second at 24 FPS. Some users may use other shutter angles that mimic old 1950's newsreels (shorter than) 180°.

The camera resolution directly corresponds to light information. In other words, the Bayer sensor may match one pixel to a color and light intensity (each pixel corresponds to a photosite). However, the camera resolution does not directly correspond to light information. Some high-resolution cameras use an N-Bayer sensor that groups four, or even nine, pixels per photosite. During image signal processing, color information is re-distributed across the pixels with a technique called “pixel binning”. Pixel-binning provides better results and versatility than just interpolation/upscaling. For example, a camera can capture high resolution images (e.g., 108 MPixels) in full-light; but in low-light conditions, the camera can emulate a much larger photosite with the same sensor (e.g., grouping pixels in sets of 9 to get a 12 MPixel “nona-binned” resolution). Unfortunately, cramming photosites together can result in “leaks” of light between adjacent pixels (i.e., sensor noise). In other words, smaller sensors and small photosites increase noise and decrease dynamic range.

The microphone 812 senses acoustic vibrations and converts the vibrations to an electrical signal (via a transducer, condenser, etc.) The electrical signal may be further transformed to frequency domain information. The electrical signal is provided to the audio codec, which samples the electrical signal and converts the time domain waveform to its frequency domain representation. Typically, additional filtering and noise reduction may be performed to compensate for microphone characteristics. The resulting audio waveform may be compressed for delivery via any number of audio data formats.

Commodity audio codecs generally fall into speech codecs and full spectrum codecs. Full spectrum codecs use the modified discrete cosine transform (mDCT) and/or mel-frequency cepstral coefficients (MFCC) to represent the full audible spectrum. Speech codecs reduce coding complexity by leveraging the characteristics of the human auditory/speech system to mimic voice communications. Speech codecs often make significant trade-offs to preserve intelligibility, pleasantness, and/or data transmission considerations (robustness, latency, bandwidth, etc.)

More generally however, the various techniques described herein may be broadly applied to any integrated or handheld microphone or set of microphones including, e.g., boom and/or shotgun-style microphones. Multiple microphones may be used to collect stereo sound and/or enable audio processing. For example, any number of individual microphones can be used to constructively and/or destructively combine acoustic waves (also referred to as beamforming).

The inertial measurement unit (IMU) includes one or more accelerometers, gyroscopes, and/or magnetometers. The accelerometer (ACCL 814) measures acceleration and gyroscope (GYRO 816) measure rotation in one or more dimensions. These measurements may be mathematically converted into a four-dimensional (4D) quaternion to describe the device motion, and electronic image stabilization (EIS) may be used to offset image orientation to counteract device motion (e.g., CORI/IORI 820). The magnetometer (MAGN 818) may provide a magnetic north vector (which may be used to “north lock” video and/or augment location services such as GPS), similarly the accelerometer (ACCL 814) may also be used to calculate a gravity vector (GRAV 822).

Typically, an accelerometer uses a damped mass and spring assembly to measure proper acceleration (i.e., acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both device direction and speed).

More generally, however, any scheme for detecting device velocity (direction and speed) may be substituted with equal success for any of the foregoing tasks. While the foregoing techniques are described in the context of an inertial measurement unit (IMU) that provides quaternion vectors, artisans of ordinary skill in the related arts will readily appreciate that raw data (acceleration, rotation, magnetic field) and any of their derivatives may be substituted with equal success.

Functionally, the user interface subsystem 824 may be used to present media to, and/or receive input from, a human user. Media may include any form of audible, visual, and/or haptic content for consumption by a human. Examples include images, videos, sounds, and/or vibration. Input may include any data entered by a user either directly (via user entry) or indirectly (e.g., by reference to a profile or other source).

The user interface subsystem 824 may include: a touchscreen, physical buttons, and a microphone. Input may be interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

Other user interface subsystems may multiply, combine, further sub-divide, augment, and/or subsume the foregoing functionalities within these or other subsystems. For example, the audio input may incorporate elements of the microphone (discussed above with respect to the sensor subsystem). Similarly, IMU based input may incorporate the aforementioned IMU to measure “shakes”, “bumps” and other gestures.

The user interface subsystem 824 is incorporated within the dynamic encoding device 800. In other embodiments, the user interface subsystem may be augmented by external devices and/or removably attached components (e.g., hot-shoe/cold-shoe attachments, etc.) The following sections provide detailed descriptions of the individual components of the sensor subsystem.

The user interface subsystem 824 may include a touchscreen panel. A touchscreen is an assembly of a touch-sensitive panel that has been overlaid on a visual display. Typical displays are liquid crystal displays (LCD), organic light emitting diodes (OLED), and/or active-matrix OLED (AMOLED). Touchscreens are commonly used to enable a user to interact with a dynamic display, this provides both flexibility and intuitive user interfaces. Within the context of action cameras, touchscreen displays are especially useful because they can be sealed (waterproof, dust-proof, shock-proof, etc.)

Most commodity touchscreen displays are either resistive or capacitive. Generally, these systems use changes in resistance and/or capacitance to sense the location of human finger(s) or other touch input. Other touchscreen technologies may include, e.g., surface acoustic wave, surface capacitance, projected capacitance, mutual capacitance, and/or self-capacitance. Yet other analogous technologies may include, e.g., projected screens with optical imaging and/or computer-vision.

The user interface subsystem 824 may also include mechanical buttons, keyboards, switches, scroll wheels and/or other mechanical input devices. Mechanical user interfaces are usually used to open or close a mechanical switch, resulting in a differentiable electrical signal. While physical buttons may be more difficult to seal against the elements, they are nonetheless useful in low-power applications since they do not require an active electrical current draw. For example, many BLE applications may be triggered by a physical button press to further reduce GUI power requirements.

More generally, however, any scheme for detecting user input may be substituted with equal success for any of the foregoing tasks. While the foregoing techniques are described in the context of a touchscreen and physical buttons that enable user data entry, artisans of ordinary skill in the related arts will readily appreciate that any of their derivatives may be substituted with equal success.

Audio input may incorporate a microphone and codec (discussed above) with a speaker. As previously noted, the microphone can capture and convert audio for voice commands. For audible feedback, the audio codec may obtain audio data and decode the data into an electrical signal. The electrical signal can be amplified and used to drive the speaker to generate acoustic waves.

As previously noted, the microphone and speaker may have any number of microphones and/or speakers for beamforming. For example, two speakers may be used to provide stereo sound. Multiple microphones may be used to collect both the user's vocal instructions as well as the environmental sounds.

Functionally, the communication subsystem may be used to transfer data to, and/or receive data from, external entities. The communication subsystem is generally split into network interfaces and removeable media (data) interfaces. The network interfaces are configured to communicate with other nodes of a communication network according to a communication protocol. Data may be received/transmitted as transitory signals (e.g., electrical signaling over a transmission medium.) The data interfaces are configured to read/write data to a removeable non-transitory computer-readable medium (e.g., flash drive or similar memory media).

The illustrated network/data interface 826 may include network interfaces including, but not limited to: Wi-Fi, Bluetooth, Global Positioning System (GPS), USB, and/or Ethernet network interfaces. Additionally, the network/data interface 1026 may include data interfaces such as: SD cards (and their derivatives) and/or any other optical/electrical/magnetic media (e.g., MMC cards, CDs, DVDs, tape, etc.)

The communication subsystem including the network/data interface 826 of the dynamic encoding device 800 may include one or more radios and/or modems. As used herein, the term “modem” refers to a modulator-demodulator for converting computer data (digital) into a waveform (baseband analog). The term “radio” refers to the front-end portion of the modem that upconverts and/or downconverts the baseband analog waveform to/from the RF carrier frequency.

As previously noted, communication subsystem with network/data interface 826 may include wireless subsystems (e.g., 5th/6th Generation (5G/6G) cellular networks, Wi-Fi, Bluetooth (including, Bluetooth Low Energy (BLE) communication networks), etc.) Furthermore, the techniques described throughout may be applied with equal success to wired networking devices. Examples of wired communications include without limitation Ethernet, USB, PCI-e. Additionally, some applications may operate within mixed environments and/or tasks. In such situations, the multiple different connections may be provided via multiple different communication protocols. Still other network connectivity solutions may be substituted with equal success.

More generally, any scheme for transmitting data over transitory media may be substituted with equal success for any of the foregoing tasks.

The communication subsystem of the dynamic encoding device 800 may include one or more data interfaces for removeable media. The dynamic encoding device 800 may read and write from a Secure Digital (SD) card or similar card memory.

While the foregoing discussion is presented in the context of SD cards, artisans of ordinary skill in the related arts will readily appreciate that other removeable media may be substituted with equal success (flash drives, MMC cards, etc.) Furthermore, the techniques described throughout may be applied with equal success to optical media (e.g., DVD, CD-ROM, etc.).

More generally, any scheme for storing data to non-transitory media may be substituted with equal success for any of the foregoing tasks.

Functionally, the control and data processing subsystems are used to read/write and store data to effectuate calculations and/or actuation of the sensor subsystem, user interface subsystem, and/or communication subsystem. While the following discussions are presented in the context of processing units that execute instructions stored in a non-transitory computer-readable medium (memory), other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As shown in FIG. 8, the control and data subsystem may include one or more of: a central processing unit (CPU 806), an image signal processor (ISP 802), a graphics processing unit (GPU 804), a codec 808, and a non-transitory computer-readable medium 828 that stores program instructions and/or data. In some implementations, a neural network processing unit (NPU 807) may additionally be included for machine-learning applications.

As a practical matter, different processor architectures attempt to optimize their designs for their most likely usages. More specialized logic can often result in much higher performance (e.g., by avoiding unnecessary operations, memory accesses, and/or conditional branching). For example, a general-purpose CPU may be primarily used to control device operation and/or perform tasks of arbitrary complexity/best-effort. CPU operations may include, without limitation: general-purpose operating system (OS) functionality (power management, UX), memory management, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks and must account for branch disruption and/or arbitrary memory access.

In contrast, the image signal processor (ISP) performs many of the same tasks repeatedly over a well-defined data structure. Specifically, the ISP maps captured camera sensor data to a color space. ISP operations often include, without limitation: demosaicing, color correction, white balance, and/or auto exposure. Most of these actions may be done with scalar vector-matrix multiplication. Raw image data has a defined size and capture rate (for video), and the ISP operations are performed identically for each pixel; as a result, ISP designs are heavily pipelined (and seldom branch), may incorporate specialized vector-matrix logic, and often rely on reduced addressable space and other task-specific optimizations. ISP designs only need to keep up with the camera sensor output to stay within the real-time budget; thus, ISPs more often benefit from larger register/data structures and do not need parallelization. In many cases, the ISP may locally execute its own real-time operating system (RTOS) to schedule tasks of according to real-time constraints.

Much like the ISP, the GPU is primarily used to modify image data and may be heavily pipelined (seldom branches) and may incorporate specialized vector-matrix logic. Unlike the ISP however, the GPU often performs image processing acceleration for the CPU, thus the GPU may need to operate on multiple images at a time and/or other image processing tasks of arbitrary complexity. In many cases, GPU tasks may be parallelized and/or constrained by real-time budgets. GPU operations may include, without limitation: stabilization, lens corrections (stitching, warping, stretching), image corrections (shading, blending), noise reduction (filtering, etc.). GPUs may have much larger addressable space that can access both local cache memory and/or pages of system virtual memory. Additionally, a GPU may include multiple parallel cores and load balancing logic to e.g., manage power consumption and/or performance. In some cases, the GPU may locally execute its own operating system to schedule tasks according to its own scheduling constraints (pipelining, etc.).

The hardware codec converts image data to an encoded data for transfer and/or converts encoded data to image data for playback. Much like ISPs, hardware codecs are often designed according to specific use cases and heavily commoditized. Typical hardware codecs are heavily pipelined, may incorporate discrete cosine transform (DCT) logic (which is used by most compression standards), and often have large internal memories to hold multiple frames of video for motion estimation (spatial and/or temporal). As with ISPs, codecs are often bottlenecked by network connectivity and/or processor bandwidth, thus codecs are seldom parallelized and may have specialized data structures (e.g., registers that are a multiple of an image row width, etc.). In some cases, the codec may locally execute its own operating system to schedule tasks according to its own scheduling constraints (bandwidth, real-time frame rates, etc.).

Other processor subsystem implementations may multiply, combine, further sub-divide, augment, and/or subsume the foregoing functionalities within these or other processing elements. For example, multiple ISPs may be used to service multiple camera sensors. Similarly, codec functionality may be subsumed with either GPU or CPU operation via software emulation.

In one embodiment, the memory subsystem may be used to store data locally at the dynamic encoding device 800. In one exemplary embodiment, data may be stored as non-transitory symbols (e.g., bits read from non-transitory computer-readable mediums.) In one specific implementation, the memory subsystem including non-transitory computer-readable medium 828 is physically realized as one or more physical memory chips (e.g., NAND/NOR flash) that are logically separated into memory data structures. The memory subsystem may be bifurcated into program code 830 and/or program data 832. In some variants, program code and/or program data may be further organized for dedicated and/or collaborative use. For example, the GPU and CPU may share a common memory buffer to facilitate large transfers of data therebetween. Similarly, the codec may have a dedicated memory buffer to avoid resource contention.

In some embodiments, the program code may be statically stored within the dynamic encoding device 800 as firmware. In other embodiments, the program code may be dynamically stored (and changeable) via software updates. In some such variants, software may be subsequently updated by external parties and/or the user, based on various access permissions and procedures.

### Encoder Control

While the following discussion is presented in the context of the dynamic encoding device 800 of FIG. 8, artisans of ordinary skill in the related arts will readily appreciate that the concepts described below may be broadly extended to any device that performs dynamic encoding locally (in-device). In-device dynamic encoding may have broadly applicability to a variety of other encoding applications e.g., streaming video content, 360° video, augmented reality/virtual reality and other hybrid realities, video conferencing, video editing and post-processing, surveillance systems, and any number of other media applications.

In one embodiment, the non-transitory computer-readable medium includes a routine that enables dynamic encoder configuration. When executed by the control and data subsystem, the routine causes the capture device to: monitor a first memory size, determine a second memory performance, and dynamically adjust an encoder parameter. The following discussion describes each step in more detail.

At step 842, the dynamic encoding device measures a first memory size. In one embodiment, the dynamic encoding device includes a first-in-first-out (FIFO) memory buffer. Here, a memory buffer temporarily holds data to smooth out instantaneous rate differences. While the foregoing discussions are presented in the context of FIFO memory buffers, other buffering technologies may be substituted with equal success including without limitation: last-in-first-out (LIFO), circular buffers, double buffers, triple buffers, ping-pong buffers, shared memory buffers and/or direct memory access (DMA), etc.

The first memory buffer is filed with data. In one embodiment, media may be generated or otherwise created. For example, a capture device may capture data which is encoded to media by an encoder. Other examples may include e.g., computer-generated graphics and/or computer-modeling may be used to generate video content. Generative artificial intelligence technologies have matured and can also generate a variety of different content (e.g., images, video, audio, etc.). Such techniques may be substituted with equal success by artisans of ordinary skill in the related arts.

Here, “media” refers to data that may be edited, modified, spliced, rendered, replayed, and/or otherwise designed to be manipulated/consumed by a human. Typically, “media” refers to text, images, audio, video, and interactive content. Media may have associated metadata—this metadata describes the media. Dynamic media refers to media that is characterized by a time (or space) varying behavior. Similarly, dynamic metadata refers to metadata that is characterized by a time (or space) varying behavior. For example, video is a sequence of frames (images) which are played over time; a dynamic metadata track may provide information that varies as a function of the video's time reference. Dynamic metadata is distinguished from static metadata which does not vary over time; e.g., “title”, “artist”, etc.

In one embodiment, the first memory size is dynamically measured. In one embodiment, the first memory size is measured by comparing the filling rate/throughput to draining rate/throughput of the memory buffer. In other embodiments, the first memory size may be measured by determining the data throughput of the first memory. In still other variants, the memory buffer may be measured by e.g., frequency of ping ponging, switching, etc. Various other schemes for measuring memory performance may be substituted with equal success.

As used herein, the term “fill” and its linguistic derivatives refer to data that is added to a memory. The term “drain” and its linguistic derivatives refer to data that is being removed from memory. Typically, memory buffers are filled when written, and drained when read—however, not all systems may be read and write. For example, shared memories and/or DMA based memories may be filled/drained by logically discrete entities, e.g., the dynamic encoding device may only perform one of the filling/draining, etc. More generally, the terms broadly encompass any measurement of data flow.

In one embodiment, measurements are performed dynamically, according to real-time constraints. For example, in a video capture, the measurements may be performed at periodic time intervals that correspond to fixed video intervals (1 sec increments, 2 sec increments, etc.), groups of pictures (GOPs), and/or other salient video aligned events. In other cases, the measurements may be performed at a specific frequency, or rate. Aperiodic measurements may be used where behavior is predictably bursty, variable, and/or explicitly triggered.

At step 844, the dynamic encoding device determines a second memory performance based on the first memory size. In one specific implementation, the second memory performance is hidden, shielded from external access, and/or otherwise obscured to the dynamic encoding device, and the second memory performance is indirectly inferred (rather than directly measured). For example, the second memory device may incorporate internal logic of indeterminate scheduling e.g., an SD card may have internal memory management functionality (mapping, wear-leveling, error correction, etc.) that is externally masked using onboard caching, etc.

In one embodiment, the inferred performance of the second memory device is based on the measured size of the first memory. In one embodiment, the inferred performance is based on a rate of change of the memory size (e.g., a fill rate, a drain rate, an overall throughput, etc.).

More generally, the magnitude of the first memory may be used to calculate derivatives (change) and/or integrals (accumulation). For example, a measured magnitude may provide a vector (derivative of a magnitude), a change vector (derivative of a vector), a hysteresis (integral of a magnitude), and/or any other higher order integral or derivative of the measured magnitude. More generally, any metric may be used to quantify the first memory size, or its change in size, may be substituted with equal success.

At step 846, the capture device dynamically selects an encoding configuration to encode the media, based on the second memory performance. Here, “encoding” refers to apparatus and techniques that represent media within a structured data format; encoding is often used to optimize data for transmission, storage, rendering, presentation, and/or processing. For example, certain encodings may seek to reduce file size, reject data corruption, preserve signal fidelity, reduce latency, etc.

Encoding is performed with a codec that may be configured with an “encoding configuration” via an application programming interface (API). An API is a set of protocols that allows a software/firmware application to communicate with other entities. APIs may provide abstraction, interoperability, standardization, and/or security to software systems. Abstraction hides underlying machinations of the software application—this ensures distinct divisions in software architectures to prevent “bleed-through” of data between different processes. Interoperability and standardization enable different systems work together consistently and robustly. APIs may also provide various layers of security to avoid malicious actors, etc.

API-based configuration may be useful in mobile ecosystems that incorporate different devices of different capabilities. Generally, mobile ecosystems rely on mass-produced “commodity” codecs that are widely available and standardized. More generally, API-based codec configuration may be found in any system that uses “black box” and “white box” components. Here, “black box” refers to a system or component that hides its internal processes from other entities; only the inputs and outputs are observable. A “white box” refers to a system or component that exposes its internal machinations to other entities—in some cases, a white box may even allow direct manipulation of its data and/or processes.

Encoding configurations and other aspects of dynamic encoders are discussed in greater detail within U.S. application Ser. No. 18/701,256, filed Apr. 15, 2024, and entitled “METHODS AND APPARATUS FOR REAL-TIME GUIDED ENCODING”, and U.S. application Ser. No. 18/423,533, filed Jan. 26, 2024, and entitled “METHODS AND APPARATUS FOR DYNAMIC CODEC CONFIGURATION”, each of the foregoing previously incorporated by reference in their entireties.

While the foregoing discussions are presented in the context of an API-based encoding configuration, virtually any technique may be used to dynamically configure a codec to encode media. For example, direct access implementations may allow an external entity to directly access and/or adjust codec configuration. Other implementations may use a file-based scheme that provides codec configurations according to an alignment scheme (e.g., the file structure timestamp encoder configurations). Embedded and/or hardware-based logic may be used to directly control encoder configuration, etc.

In one embodiment, selection is based on a user-specified configuration. As a practical matter, a user likely will not provide input at a dynamic rate (e.g., once every second, etc.), instead, a base user configuration may be used to inform logic that performs dynamic encoder control. In one such implementation, a user may select one or more “user-friendly” configurations (e.g., “maximum quality”, “instant share/network streaming”, “timelapse”, etc.) that are interpreted by dynamic encoder control logic to select the appropriate encoder configuration in real-time e.g., based on the second memory performance. In other embodiments, a user may identify the desired qualities and/or limitations (e.g., maximum bitrate, image quality PSNR (peak signal-to-noise ratio), etc.) which set the corresponding parameters of encoder configuration.

While the foregoing discussion is presented in the context of a camera user, the concepts may be more broadly expanded to other entities and/or applications. Human entities might include e.g., users, groups (such as audiences), and/or remote operators. For example, a smart phone may enable its user to transcode an existing video file, etc. In another such example, a camera might live stream video to a number of humans, each of which might have different selection requirements. These selection requirements may be used to select/determine a number of encoding instances; in some cases, selections may be combined and/or cascaded to reduce the number of active encoding instances. Furthermore, multi-camera rigs are commonly used in certain special effects—in such implementations, the multi-camera rig may be coordinated by a single central point to ensure seamless transitions between camera angles, etc. Selection logic for a multi-camera rig may be propagated to all cameras of the rig in real-time to ensure that transitions between any of the camera views would be visually seamless.

In one specific implementation, encoding configuration selection may consider the second memory performance in combination with other real-time guidance (e.g., quantization, compression, bit rate adjustment, and/or group of picture (GOP) sizing may be based on parameters provided from upstream image processing pipeline (IPP) operations). Real-time guidance can update and/or correct the encoding configuration during and (in some variants) throughout a live capture. For example, various stages of an IPP can use capture and conversion statistics and sensed motion data to configure the encoding parameters prior to image signal processing. In another such example, selection logic may use quantization parameters based on auto exposure and color space conversion statistics for the output images. In some cases, quantization parameters may be based on pixel motion vectors obtained from the temporal denoising. Where available, facial recognition, scene classification, and/or region-of-interest (ROI) metadata may also be used.

Real-time guidance may include ongoing encoding information. For example, encoder feedback may be used to determine GOP sizing. Similar adjustments may be made to compression and bit rate adjustments. The real-time guidance information from codec operation may be retrieved in advance of encoding—this is a function of the IPP's pipelining. More directly, instead of buffering 1 second of images within the codec so that the codec can perform look-forward/look-behind prediction (also referred to as forward/backward prediction), the selection logic may configure the codec's encoding parameters based on real-time guidance provided by earlier stages of the IPP.

While the foregoing discussion is presented in the context of an in-device image processing pipeline with a specific set of stages (e.g., an image signal processing stage, a stabilization and denoising stage, and an encoding stage) the concepts may be broadly applied to a variety of other processing pipelines. For example, some devices may incorporate communication stages (e.g., transmit/receive, encryption/decryption, etc.) for transmission over signaling media. Other devices may incorporate machine-learning, graphics processing, and/or other media manipulation stages. Yet other devices may include data analysis, filtering, and/or other monitoring stages. More generally, the encoder is just one processing element in a pipeline of processing elements. Each pipeline stage processes the data in sequence, and many issues that might affect encoding are also likely to affect pre-and-post-processing as well. Thus, the concepts may be broadly extended to any information from other processing stages that might be used to select encoder configuration.

Dynamic media may be encoded into data structure(s) according to its dynamic encoding configuration. In one embodiment, the encoding may be realized as “tracks” which may be aligned to one another (e.g., time-aligned, space-aligned, etc.). For example, a dynamic media data structure may include a dynamic media track (e.g., a video track and/or audio track, etc.) that may be aligned to a dynamic metadata track (e.g., image features, encoding features, etc.) according to a frame-by-frame basis or by group of pictures (GOP). In some cases, the encoding may be in a combined format (e.g., dual track, multi-track, etc.); alternatively, the encoding may be separated (e.g., a video data structure and a separate “sidecar” data structure—the sidecar may be aligned using timestamps, frame numbers, etc.).

More broadly, the encoded data structure may be extended to any data structure that allows for dynamic (varying) associations between the media information and its encoding considerations. The associations may be based on time, space, complexity, features and/or any other salient consideration. While the foregoing discussions are presented in the context of data structures that are recorded within non-transitory computer-readable media, the concepts may be broadly extended to transitory signals. For example, instead of writing to a file structure, the dynamic media may be streamed as signaling (e.g., wireless and/or wired signals).

The foregoing discussion has been framed in the context of a real-time operating system (RTOS) that schedules tasks for completion within definitive constraints. More generally however, the concepts may be broadly extended to high-level operating systems (OSes) which are typically best-effort. Notably, high-level OSes must dynamically manage varying task loads; in some cases, this may affect encoding quality. For example, a laptop running a low priority variable rate encoder may also have other applications running in the background. Under some conditions, the laptop may consider background memory usage when selecting encoder configuration since the encoding quality may be strongly affected by available memory resources. Other examples of processor-based selection criteria may include e.g., task load, memory load, memory availability, network bandwidth, power consumption, interrupt frequency, etc. More generally, selection heuristics may be broadly extended to any processing resource that might affect the encoded quality.

### ADDITIONAL CONFIGURATION CONSIDERATIONS

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein any reference to any of “one embodiment” or “an embodiment”, “one variant” or “a variant”, and “one implementation” or “an implementation” means that a particular element, feature, structure, or characteristic described in connection with the embodiment, variant or implementation is included in at least one embodiment, variant, or implementation. The appearances of such phrases in various places in the specification are not necessarily all referring to the same embodiment, variant, or implementation.

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

As used herein, the terms “camera” or “image capture device” may be used to refer without limitation to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting but rather should be taken as illustrative of the general principles of the technology. The scope of the disclosure should be determined with reference to the claims.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
reading at least one pointer location of a memory buffer at a plurality of time intervals;
inferring a performance of a removable memory card, based on the at least one pointer location;
selecting an encoder parameter based on the performance of the removable memory card;
encoding at least one image into at least one frame based on the encoder parameter; and
writing the at least one frame to the memory buffer.

2. The method of claim 1, where the memory buffer comprises a first-in-first-out memory buffer and where the at least one pointer location comprises a write pointer and a read pointer.

3. The method of claim 2, where inferring the performance of the removable memory card comprises determining a fill rate and a drain rate of the memory buffer.

4. The method of claim 1, where inferring the performance of the removable memory card comprises determining at least one throughput of the memory buffer.

5. The method of claim 1, further comprising presenting the performance of the removable memory card to a user via a user interface.

6. The method of claim 5, further comprising capturing the at least one image, and where capturing the at least one image and presenting the performance of the removable memory card are performed in real-time.

7. The method of claim 5, where encoding the at least one image, and presenting the performance of the removable memory card are performed in real-time.

8. The method of claim 5, where writing the at least one frame, and presenting the performance of the removable memory card are performed in real-time.

9. An apparatus, comprising:
a codec;
a memory buffer;
a memory interface configured to communicate with a removable memory card;
a processor; and
a non-transitory computer-readable medium comprising instructions that when executed by the processor, cause the processor to:
monitor a first size of the memory buffer;
infer a performance of the removable memory card based on the first size; and
dynamically configure the codec based on the performance.

10. The apparatus of claim 9, where the memory buffer is filled according to a real-time schedule, and the removable memory card is configured to communicate according to a best-effort schedule.

11. The apparatus of claim 9, where the apparatus further comprises a sensor subsystem configured to capture images for the codec to encode in real-time.

12. The apparatus of claim 9, where the memory buffer is monitored via a write pointer location and a read pointer location.

13. The apparatus of claim 9, further comprising a user interface configured to present the performance of the removable memory card to a user in real-time.

14. The apparatus of claim 13, where the user interface is further configured to present the performance of the removable memory card to the user continuously over multiple time intervals of live data.

15. A non-transitory computer-readable medium comprising instructions that when executed by a processor, cause the processor to:
monitor a first size of a memory buffer;
infer a performance of a hidden memory based on the first size; and
dynamically configure a codec based on the performance.

16. The non-transitory computer-readable medium of claim 15, where the hidden memory comprises a removable memory card.

17. The non-transitory computer-readable medium of claim 15, where the hidden memory comprises a memory logic that is configured to internally manage at least one of mapping, wear-leveling, and error correction.

18. The non-transitory computer-readable medium of claim 15, where the hidden memory operates according to a best-effort schedule, and the codec operates according to a real-time schedule.

19. The non-transitory computer-readable medium of claim 15, where the instructions further cause the processor to present the performance to a user in real-time.

20. The non-transitory computer-readable medium of claim 15, where the instructions further cause the processor to present the performance in association with an ongoing real-time capture.
